(19) United States
(12) Patent Application Publication
(10) Pub. No.: US 2017/0129454 A1
(43) Pub. Date: May 11, 2017

(54) SAFETY SYSTEM AND METHOD FOR PREVENTING LIVING BODY FROM BEING LOCKED IN VEHICLE

(71) Applicant: Unimicron Technology Corp., Taoyuan (TW)

(72) Inventors: Pei-Chang HUANG, Taoyuan (TW); Cheng-Po YU, Taoyuan (TW)

(21) Appl. No.: 14/936,697

(22) Filed: Nov. 10, 2015

(51) Int. Cl. B60R 22/48; B60Q 9/00

(52) U.S. Cl. CPC B60R 22/48; B60Q 9/00; B60R 2022/4883; B60R 2022/4816

(57) ABSTRACT

A safety system for preventing a living body from being locked in a vehicle comprises a warning unit, a detection device and a limiting device. The detection device is disposed in a passenger's protection device which has to be used by a passenger when the vehicle is being driven. The detection device detects whether the passenger's protection device is in use or not to generate a corresponding detection signal. The warning unit turns on or turns off a warning device according to the detection signal and generates a corresponding control signal. The limiting device locks the vehicle key in the key slot or to release the vehicle key from the key slot according to the control signal after the vehicle has been parked.

### BACKGROUND

Field of Invention

The invention relates to a safety system, and more particularly relates to a safety system for preventing a living body from being locked in a vehicle.

Description of Related Art

In recent years, with the rapid economy development, more and more people use cars as daily transportation tools to pick up family members. Therefore, users often have the same experiences of picking up young children or elderly people. Under normal conditions, the users do not leave the young children or the elderly people in the car alone. However, sometimes, under certain special conditions, the users may forget that the young children or the elderly people are still in the car alone when they lock and leave their cars, thus often causing young children or the elderly people to suffer severe injuries.

Typically, in order to prevent the above situation from happening, an infrared detection method, a temperature detection method, or a seat stress detection method is used to detect if there is a living body in a car after the car is parked and its doors and windows are closed. If a living body is locked in the car mistakenly, a remedial action is started, such as automatically lowering the windows, turning on the air condition system, generating an alarm or sending a text message to the car owner or ambulance personnel. However, the above remedial action is usually started after a person has been trapped in a car for a certain period of time. Therefore, once the trapped person has a high-risk disease, such as heart disease, high blood pressure, etc., it is very like to result in irreparable harm before the remedial action is started even when the person is trapped in the car in a very short period of time.

In view of the above problems, there is a need to provide a safety system and a safety method for preventing a living body from being locked in a vehicle.

### SUMMARY

Accordingly, the present invention provides a safety system for preventing a living body from being locked in a vehicle. The safety system is implemented in the vehicle to check whether a passenger still remains in the vehicle or not after the vehicle has been parked. The safety system comprises a warning unit, a detection device and a limiting device. The detection device is disposed in a passenger's protection device of the vehicle, which has to be used by the passenger cooperatively when the vehicle is being driven. The detection device detects whether the passenger's protection device is in use or not, thereby generating a corresponding detection signal. The warning unit turns on or turns off a warning device according to the detection signal and generates a corresponding control signal. The limiting device locks the vehicle key in the key slot or to release the vehicle key from the key slot according to the control signal after the car has been parked.

In an embodiment, the limiting device is a latch or a magnetic element disposed in the key slot.

In an embodiment, the warning device is a display that may display a seating table of the vehicle. The warning unit highlights at least one seat or remove the highlight in the seating table according to the detection signal. 100081 In an embodiment, the passenger's protection device is a seatbelt. The detection device is an insertion detection device disposed in the seat belt buckle slot.

In an embodiment, the control signal comprises a first control signal and a second control signal. When the insertion detection device detects that the seat belt insert is plugged into the seat belt buckle slot, the warning unit turns on the warning device according to the detection signal and generates the first control signal. When the insertion detection device does not detect that the seat belt insert is plugged into the seat belt buckle slot, the warning unit turns off the warning device according to the detection signal and generates the second control signal.

In an embodiment, the limiting device receives the first control signal to lock the vehicle key in the key slot according to the first control signal after the car has been parked.

In an embodiment, the limiting device receives the second control signal to release the vehicle key from the key slot according to the second control signal after the car has been parked.

The present invention also provides a method for preventing a living body from being locked in a vehicle. The method is suitable for use in a vehicle to check whether a passenger still remains in the vehicle or not after the vehicle has been parked. The method uses a detection device to detect whether a passenger's protection device is in use or not, thereby generating a corresponding detection signal. The passenger's protection device of a vehicle has to be used by the passenger when the vehicle is being driven. Next, the detection signal is used to determine whether the passenger remains in the vehicle or not. When a passenger still remains in the vehicle, a limiting device locks the vehicle key in the key slot after the car has been parked.

In an embodiment, the method further comprises to control the limiting device to release the vehicle key from the key slot after the car has been parked when there is no passenger in the vehicle.

In an embodiment, the method further comprises turning on a corresponding warning device when the passenger's protection device is used and it is determined that the passenger still remains in the vehicle.

Accordingly, the safety system and method for preventing a living body from being locked in a vehicle may check whether a passenger's protection device is in use or not before the vehicle driver parks the vehicle and leaves. Once a passenger remains in the vehicle, a coercive measure is used, for example, to lock the vehicle key in the key slot so as to remind the vehicle driver. Therefore, a precedent warning and reminder is used in the present invention to prevent a passenger from being locked in the vehicle more effectively.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 illustrates a schematic diagram of a safety system according to an embodiment of the invention; and

FIG. 2 illustrates a flow chart of operating the safety system according to an embodiment of the invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts. It is noted that, in accordance with the standard practice in the industry, various features are not drawn to scale. In fact, the dimensions of the various features may be arbitrarily increased or reduced for clarity of discussion.

According to the present invention, the safety system takes a precedent protective manner for preventing a living body from being locked in a vehicle. Before a vehicle driver parks and leaves a vehicle, a safety system may warn the vehicle driver to see if a passenger still remains in the vehicle. Once the passenger still remains in the vehicle in the vehicle, a coercive measure is used, for example, to lock the vehicle key in the key slot so as to remind the vehicle driver. In other words, precedent warning and reminder are used in the present invention to prevent a passenger from being locked in a vehicle more effectively.

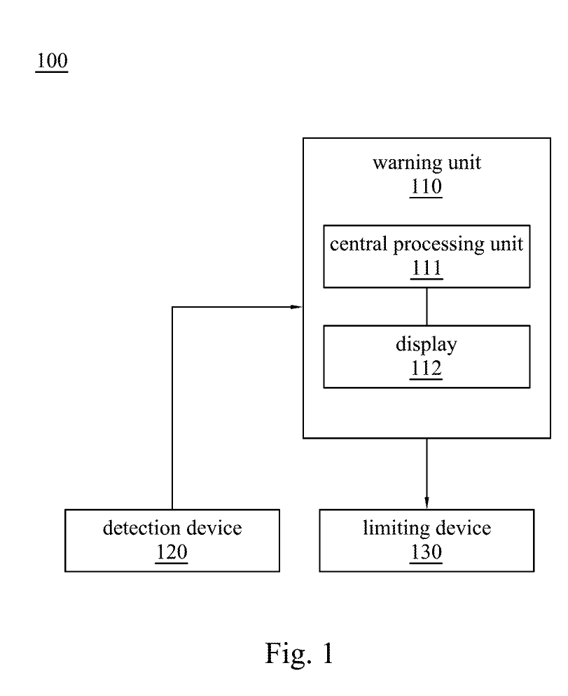

FIG. 1 illustrates a schematic diagram of a safety system 100 according to an embodiment of the invention. The safety system 100 is implemented in a vehicle to check whether a passenger still remains in a vehicle or not after the vehicle has been parked. Therefore, the safety system 100 may prevent a living body from being locked in a vehicle. The safety system 100 comprises a warning unit 110, a detection device 120 and a limiting device 130.

The detection device 120 is disposed in a passenger's protection device of a vehicle, and is required to be used when the vehicle is been driven. The detection device 120 detects whether the passenger's protection device is in use or not. If the passenger's protection device is in use, the detection device 120 determines that a passenger is still in the vehicle. In an embodiment, the passenger's protection device is a seat belt. The detection device 120 is an insertion detection device. The insertion detection device may detect whether a seat belt insert is plugged into a corresponding buckle slot or not. Accordingly, the insertion detection device is disposed in each buckle slot in a vehicle. When a seat belt insert is plugged into its corresponding buckle slot, the insertion detection device may detect the insertion event. Then, a sensed insertion event signal is converted into a detection signal by the insertion detection device, and the detection signal is transmitted to the remote warning unit 110 through a circuit route.

The warning unit 110 displays the situation of the passenger in a display according to the detection signal from the detection device 120, so as to inform the driver. Thus, the warning unit 110 may further include a central processing unit 111 and a display 112 coupled to the central processing unit 111. The display 112 can be integrated into an instrument panel of the vehicle, or be disposed independently in a driver's visible area. In one embodiment, the detection device 120 is an insertion detecting device. Therefore, when the central processing unit 111 receives a detection signal generated by the insertion detecting device 120 when a seat belt insert is plugged into its corresponding buckle slot, the central processing unit 111 may analyze the detection signal to determine which buckle slot's insertion detecting device generating the detection signal in the vehicle. Then, the corresponding determining result is displayed in the display 112, and the central processing unit 111 generates and transfers a first control signal to the limiting device 130. In one embodiment, the display 112 displays a corresponding seating table of the vehicle. According to the determining result, the seat of which the insertion detecting device detects an insertion event of the seat belt inserts plugged into its corresponding buckle slot is highlighted in the seating table. Different colors may be used to highlight the seats on which the insertion event happens, so as to alert the driver that some passengers still remain on the seats. In another embodiment, if the central processing unit 111 does not receive any detection signal transmitted from the insertion detecting device. That is, the vehicle's seat belts are not used, and it is determined that no passengers remain in the vehicle. At this time, the warning unit 110 generates a second control signal to the limiting device 130.

This limiting device 130 is coupled to the warning unit 110 for receiving the first control signal or the second control signal transmitted from the warning unit 110. The limiting device 130 performs a corresponding measure to limit or relieve a control device of the vehicle according to the first control signal or the second control signal. In one embodiment, the limiting device 130 is a latch or a magnetic element, and the control device is a key used to start the vehicle. Accordingly, the limiting device 130 is disposed in the key slot to limit the movement of the key in the key slot. In one embodiment, when the limiting device 130 receives the first control signal transmitted by the warning unit 110, the limiting device 130 will perform a corresponding coercive measure to limit the movement of the key. For example, when the limiting device 130 is a latch, this limiting device 130 will directly lock the key in the key slot. Therefore, the driver cannot pull out the key from the key slot. In another embodiment, when the limiting device 130 is a magnetic element, the limiting device 130 can use the magnetic force to attract the key, so that the driver cannot pull out the key from the key slot. Thus, after the detection device 120 detects that the passenger is still in the vehicle and sends a corresponding detection signal to the warning unit 110, the warning unit 110 will generate a first control signal based on the detection signal to control the limiting device 130 to perform a corresponding coercive measure to prohibit the driver from pulling out the key from the key slot, thereby reminding the driver that a passenger still remains in the vehicle. After the above-situation is removed, that is, there are no passengers in the vehicle, the warning unit 110 generates and sends a second control signal to the limiting device 130. Then, the limiting device 130 performs a corresponding measure to release the key according to this second control signal, thus allowing the driver to pull out this key from the key slot. Accordingly, the safety system may prevent a high-risk person from being trapped inside the vehicle.

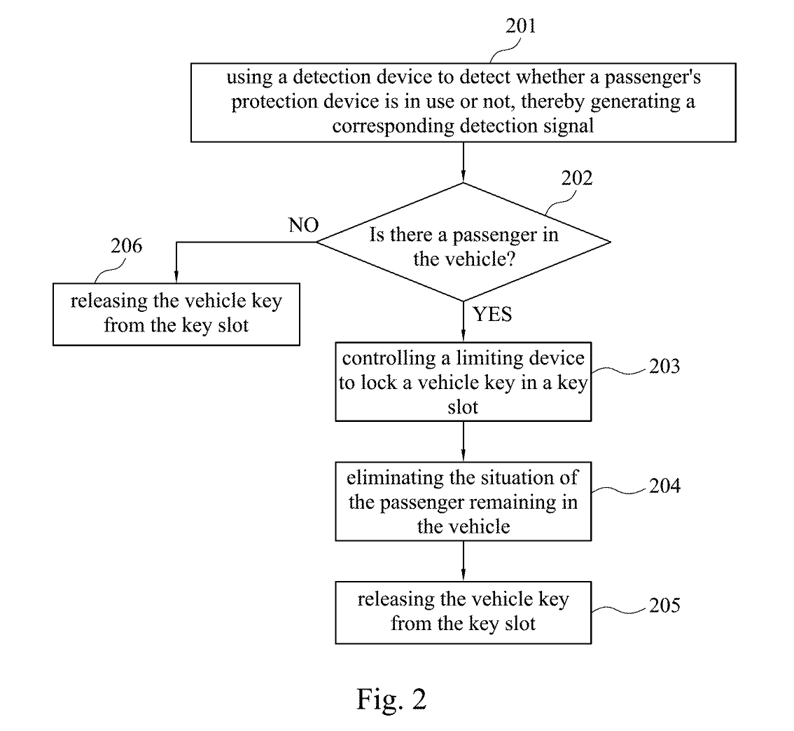

FIG. 2 illustrates a flow chart of operating the safety system according to an embodiment of the invention. The safety system 100 is implemented in a vehicle to check whether there are passengers still in the vehicle or not after the vehicle has been parked. Please refer to FIG. 1 and FIG. 2. In this embodiment, the detection device 120 is an insertion detecting device that is disposed in each seat-belt buckle slot in a vehicle. The limiting device 130 is a latch or a magnetic element that is disposed in the key slot to limit the movement of the key in the key slot. The warning unit 110 has a display 112 that is integrated into the instrument panel of the vehicle to display a seating table.

Accordingly, the safety system 100 is started after the driver turns the key to switch off the car. According to the method of operating the safety system 100, in step 201, a detection device 120 is used to detect whether a passenger's protection device which has to be used by a passenger cooperatively is in use or not when the vehicle is being driven, and to generate a corresponding detection signal. In an embodiment, the insertion detection device is used to detect whether the seat belt insert is plugged into the corresponding buckle slot or not. When a seat belt insert is plugged into its corresponding buckle slot, the insertion detection device will detect this insertion event, and generate a corresponding detection signal. Then, in step 202, a determination step is performed to determine whether a passenger is still in the vehicle. In an embodiment, the detection signal is sent to the warning unit 110. Once the warning unit 110 receives the detection signal, the warning unit 110 may determine whether the detection signal is generated according to an insertion event or not. If the detection signal is generated according to the insertion event, the warning unit 110 may determine that there are passengers in the car. The display displays the corresponding seats of the passengers to remind the driver. Then, step 203 is performed.

In step 203, a limiting device is controlled to lock the car key in the key slot. In an embodiment, after the warning unit 110 receives the detection signal that is generated by the detection device 120 according to an insertion event, a first control signal is generated to control the limiting device 130 to limit the driver from operating the key. In an embodiment, the limiting device 130 is a latch or a magnetic element. When the limiting device 130 receives the first control signal transmitted by the warning unit 110, the limiting device 130 will perform a corresponding coercive measure to lock the key in the key slot. Therefore, the driver cannot pull out the key from the key slot, which will remind the driver that there are passengers in the vehicle. Next, in step 204, the situation that the passengers remain in the vehicle is removed. For example, the passengers unfasten their seatbelts and leave the vehicle. At this time, the insertion detection device detects that the insertion event is removed. Then, the warning unit 110 generates and transmits a second control signal to the limiting device 130, and controls the display 112 to remove the warning message. After the limiting device 130 receives the second control signal, the limiting device 130 performs a corresponding measure to release the key according to this second control signal, such as removing the latch from the key, thereby allowing the driver to pull out the key from the key slot. Moreover, in another embodiment, a warning bell is added in step 203. That is, the warning unit 110 not only locks the key in the key slot, but also uses the warning bell to remind the driver.

On the other hand, if the step 203 determines that there are no passengers in the vehicle, the latch will be removed from the key to relieve the key in step 206. In an embodiment, when the seat-belts in the vehicle are not used and the insertion detection device does not detect any insertion event, the warning unit 110 generates and transmits a second control signal to the limiting device 130 to release the key, such as removing the latch from the key, thereby allowing the driver to pull out the key from the key slot according to this second control signal.

Accordingly, the safety system and method for preventing a living body from being locked in a vehicle may check whether a passenger's protection device is in use or not before the vehicle driver parks and leave the vehicle. Once a passenger still remains in the vehicle, a coercive measure is used, for example, locking the vehicle key in the key slot to remind the vehicle driver. Therefore, precedent warning and reminder are used in the present invention to prevent a passenger from being locked in the vehicle more effectively.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A safety system for preventing a living body from being locked in a vehicle, wherein the safety system is implemented in the vehicle to check whether a passenger still remains in the vehicle or not after the vehicle has been parked, the safety system comprising:
a detection device disposed in a passenger's protection device of the vehicle to detect whether the passenger's protection device is in use or not, thereby generating a corresponding detection signal, wherein the passenger's protection device has to be used by the passenger cooperatively when the vehicle is being driven;
a warning unit configured to receive the corresponding detection signal to turn on or turn off a warning device and to generate a corresponding control signal; and
a limiting device configured to receive the corresponding control signal to lock a vehicle key in a key slot or to release the vehicle key from the key slot after the vehicle has been parked.

2. The safety system of claim 1, wherein the limiting device is a latch or a magnetic element disposed in the key slot.

3. The safety system of claim 1, wherein the warning device is a display to display a seating table of the vehicle, wherein the warning unit highlights at least one seat or remove a highlight in the seating table according to the detection signal.

4. The safety system of claim 1, wherein the passenger's protection device is a seat belt, and the detection device is an insertion detection device disposed in a seat belt buckle slot.

5. The safety system of claim 4, wherein the control signal comprises a first control signal and a second control signal,
wherein when the insertion detection device detects that a seat belt insert is plugged into the seat belt buckle slot, the warning unit turns on the warning device according to the detection signal and generates the first control signal, and
when the insertion detection device does not detect that the seat belt insert is plugged into the seat belt buckle slot, the warning unit turns off the warning device according to the detection signal and generates the second control signal.

6. The safety system of claim 5, wherein the limiting device receives the first control signal to lock the vehicle key in the key slot according to the first control signal after the car has been parked.

7. The safety system of claim 5, wherein the limiting device receives the second control signal to release the vehicle key from the key slot according to the second control signal after the car has been parked.

8. A method for preventing a living body from being locked in a vehicle, wherein the method is suitable for use in a vehicle to check whether a passenger still remains in the vehicle or not after the vehicle has been parked, the method comprising:
using a detection device to detect whether a passenger's protection device is in use or not, thereby generating a corresponding detection signal, wherein the passenger's protection device has to be used by the passenger cooperatively when the vehicle is being driven;
determining whether the passenger still remains in the vehicle or not according to the detection signal; and
controlling a limiting device to lock a vehicle key in a key slot after the car has been parked when the passenger still remains in the vehicle.

9. The method of claim 8, further comprising controlling the limiting device to release the vehicle key from the key slot after the car has been parked when there is no passenger in the vehicle.

10. The method of claim 8, further comprising turning on a corresponding warning device when the passenger's protection device is used and it is determined that the passenger still remains in the vehicle.
